(19) United States
(12) Patent Application Publication
(10) Pub. No.: US 2012/0072593 A1
(43) Pub. Date: Mar. 22, 2012

(54) MULTIMEDIA CONTENT FILE MANAGEMENT SYSTEM FOR AND METHOD OF USING GENETIC INFORMATION

(76) Inventor: Ju-Yeob Kim, Incheon City (KR)

(21) Appl. No.: 13/375,119

(22) PCT Filed: May 28, 2010
(86) PCT No.: PCT/KR2010/003397

§ 371 Date: Nov. 29, 2011

(30) Foreign Application Priority Data
May 29, 2009 (KR) 10-2009-0047677

(51) Int. Cl. G06F 11/00

(52) U.S. Cl. 709/224

(57) ABSTRACT

A multimedia content file management system for and a method of monitoring copyright and watching ratings in real time under the circumstance of the multimedia file sharing service using genetic information are disclosed.

### TECHNICAL FIELD

The present invention relates to a system for and a method of managing multimedia content file using genetic information.

More particularly, the present invention relates to a system for and a method of managing a multimedia file using genetic information by receiving a file sharing program in which a content monitoring module is loaded from a file sharing service server to generate genetic information of a corresponding multimedia file in real time during transmission/downloading of a specific multimedia file, by searching for genetic information matched to pre-stored genetic information by comparing the generated genetic information with the pre-stored genetic information, by checking copyright managing information of the multimedia file having the matched genetic information to make a following action be performed, and by checking ratings of the multimedia content file before the multimedia content file is downloaded when the multimedia content file is an image data or a moving picture data to determine whether the multimedia content file is reproduced according to the ratings.

### BACKGROUND ART

Recently, file sharing through Internet is vigorously carried out.

Particularly, multimedia files such as a moving picture UCC, a song sung by a famous singer, broadcasting, and a movie are uploaded on Web so that ordinary persons can easily download the multimedia files. The multimedia files are shared and distributed by Internet service represented by P2P or a Webhard. Cases where files with copyrights among the multimedia files that are shared and distributed are also illegally uploaded on the Web and are distributed free are rapidly increased. However, the downloading and uploading of all multimedia files cannot be blindly blocked. Because this blocking may rather hinder growing of overall content industrial. A new copyright management system protecting a multimedia file copyright of which must be protected and distributing a multimedia file that must be distributed and sold with a charge, that is, a content monitoring center is needed. The content monitoring center may provide a system for protecting copyrights by blocking downloading and uploading of files whose copyrights must be protected among the multimedia files and for promoting the sales of content that must be sold with a charge and for balancing the sales margin to the copyrighter, and by doing so can contribute the development of overall content industrial.

### DISCLOSURE OF INVENTION

The present invention has been made in view of the above problem, and the present invention provides a multimedia file management system using genetic information by receiving a file sharing program in which a content monitoring module is loaded from a file sharing service server to generate genetic information of a corresponding multimedia file in real time during transmission/downloading of a specific multimedia file, by searching for genetic information matched to pre-stored genetic information by comparing the generated genetic information with the pre-stored genetic information, by checking copyright managing information of the multimedia file having the matched genetic information to make a following action be performed, and by checking ratings of the multimedia content file before the multimedia content file is downloaded when the multimedia content file is an image data or a moving picture data to determine whether the multimedia content file is reproduced according to the ratings.

The present also provides a multimedia file management system and a method using genetic information enabling to load a content monitoring module on a file sharing program which extracts audio data from a multimedia file that is distributed under circumstances of sharing files such as P2P, a Webhard, and the like and generates the extracted audio data into an audio DNA such that the file sharing program generates an audio genetic information of a multimedia file and transmits the generated audio genetic information to a monitoring center in real time when a user transmits or downloads the multimedia file so that the illegal copy and distribution of a digital authoritative work is prevented and copyrights are effectively protected and distributed.

That is, when a file that is uploaded on a web in a multimedia content file sharing service and distribution service system is shared or distributed, audio genetic information is generated to check whether there is a copyright in the corresponding multimedia file and is searched to protect the copyright of the multimedia content file so that the distribution of the multimedia content file is invigorated and overall content industrial can be grown.

In accordance with an aspect of the present invention, there is provided a multimedia content file management system using genetic information in which a multimedia file is downloaded and uploaded through a multimedia content file service server, the system including: a DNA generation module, loaded in a multimedia content file service server, to download a multimedia file uploaded on the multimedia content file service server a to generate genetic information of the multimedia file, to combine the generated genetic information with the multimedia file for transmission; and a content monitoring server to receive the multimedia file, with which the genetic information is combined, transmitted from the DNA generation module, to extract the genetic information combined with the multimedia file, and to output a compared result when there is genetic information similar to pre-stored genetic information by comparing the extracted genetic information with a pre-stored genetic information.

In accordance with another aspect of the present invention, there is provided a multimedia content file management system using genetic information in which a multimedia file is downloaded and uploaded through a multimedia content file service server, the system including: an audio DNA generation module, loaded in a multimedia content file service server, to download a multimedia file uploaded on the multimedia content file service server a to generate audio genetic information of the multimedia file, to combine the generated audio genetic information with the multimedia file for transmission; and a content monitoring server to receive the multimedia file, with which the audio genetic information is combined, transmitted from the DNA generation module, to extract the audio genetic information combined with the multimedia file, and to output a compared result when there is audio genetic information similar to pre-stored audio genetic information by comparing the extracted genetic information with a pre-stored genetic information.

In accordance with still another aspect of the present invention, there is provided a multimedia content file management system using genetic information in which a multimedia file is downloaded and uploaded through a multimedia content file service server, the system including: an audio DNA generation module loaded in the multimedia content file service server, downloading the multimedia content file that is uploaded on the multimedia content file service server to generate audio genetic information of the multimedia content file, and combining the generated audio genetic information with the multimedia content file to transmit; a content monitoring server receiving the multimedia content file, with which the audio genetic information is combined, transmitted from the audio DNA generation module, extracting the audio genetic information combined with the multimedia content file, comparing the extracted audio genetic information with pre-stored audio genetic information, transmitting the result of the comparison when there is similar audio genetic information, and constructing copyright infringement information that is received from the outside into a database to store and mange the copyright infringement information; a manager terminal displaying the compared results transmitted from the content monitoring server on a screen and transmitting copyright infringement information that is input through the compared result screen to the content monitoring server; and a data communication network allowing the multimedia content file service server, the content monitoring server, and the manager terminal to communicate with each other.

In accordance with still another aspect of the present invention, there is provided copyright managing method using audio genetic information, including: downloading a multimedia content file, by an audio DNA generation module loaded in a multimedia content file service server, that is uploaded to the multimedia content file service server; generating audio genetic information of the multimedia content file; and combining the generated audio genetic information with the multimedia content file to transmit the multimedia content file to a content monitoring server.

In accordance with still another aspect of the present invention, there is also provided a copyright managing method using audio genetic information, including: reading a multimedia content file with copyright that is registered in a multimedia file database by a content monitoring server; generating audio genetic information of the multimedia content file with copyright; and storing the generated audio genetic information as second audio genetic information in an audio genetic information database.

In accordance with still another aspect of the present invention, there is also provided a copyright managing method using audio genetic information, including: receiving a multimedia content file, with which audio genetic information is combined, transmitted from an audio DNA generation module by a content monitoring server, through a receiver module; extracting the audio genetic information from the multimedia content file output from the receiver module; comparing the audio genetic information as first audio genetic information with second audio genetic information that is registered in an audio genetic information database and determining whether there is similar genetic information as a result of the comparison; and transmitting the multimedia content file and the compared result to a manager terminal when there is similar genetic information as a result of the comparison.

Additional aspects and features of the present invention will become apparent from the following description of embodiments given in conjunction with the accompanying drawings. The present invention will be described by several embodiments with reference to the accompanying drawings but the scope of the present invention is not limited by the embodiments, thereby enabling others skilled in the art to understand the invention for various embodiments and with various modifications as are suited to the particular use contemplated. Modifications and equivalents will be apparent to practitioners skilled in this art and are encompassed within the spirit and scope of the appended claims.

According to the present invention, the multimedia files with copyrights that are illegally uploaded on a web may be monitored.

Thus, the multimedia files with copyrights cannot be illegally downloaded and this may lead to produce high quality multimedia files.

Moreover, economical benefits obtained from the production of high quality movies and music files may be maximized.

### BRIEF DESCRIPTION OF DRAWINGS

The above and other aspects and features of the present invention will become apparent from the following description of embodiments given in conjunction with the accompanying drawings, in which:

FIG. 1 is a block diagram illustrating a multimedia content file management system using genetic information according to an embodiment of the present invention;

FIG. 2 is a schematic view illustrating a copyright management system using audio genetic information according to an embodiment of the present invention;

FIG. 3 is a view illustrating a content monitoring server employed in the copyright management system of FIG. 2; and

FIGS. 4 to 6 are flowcharts illustrating an operating method of the copyright management system using audio genetic information according to an embodiment of the present invention.

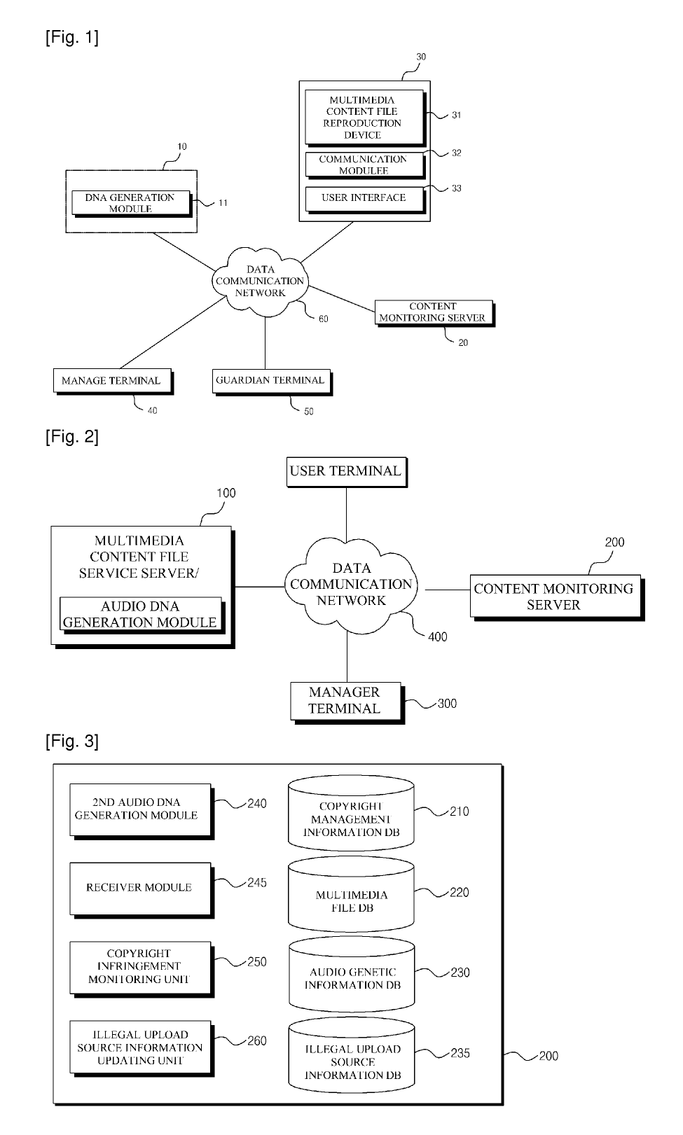

### BEST MODE FOR CARRYING OUT THE INVENTION

Hereinafter, a content monitoring system according to an embodiment of the present invention will be described in detail with reference to the accompanying drawings.

The basic principle of the present invention is that a multimedia file that is uploaded on a web is downloaded, genetic information to be identified is added to the downloaded multimedia file, and the genetic information is compared with genetic information of a pre-stored multimedia file with a copyright.

Detailed descriptions of well-known functions and structures incorporated herein may be omitted to avoid obscuring the subject matter of the present invention.

### Detailed Embodiment 1

### Case where a Multimedia Files is Image Data

FIG. 1 is a block diagram illustrating a multimedia content file management system using genetic information according to an embodiment of the present invention.

As illustrated in FIG. 1, a multimedia content file management system using genetic information according to an embodiment of the present invention includes a multimedia content file service server 10 having a DNA generation module 11, loaded in the multimedia content file service server 10, to download a multimedia file uploaded on the multimedia content file service server 10 to generate genetic information of the multimedia file, to combine the generated genetic information with the multimedia file for transmission, a content monitoring server 20 to receive the multimedia file, with which the genetic information is combined, is transmitted from the DNA generation module 11, to extract the genetic information combined with the multimedia file, and to output a compared result when there is genetic information similar to pre-stored genetic information by comparing the extracted genetic information with a pre-stored genetic information, a user terminal 30 to receive the compared result transmitted from the content monitoring server 10, to determine whether the multimedia content file selected by a user is reproduced, and to transmit the determination of reproduction to the content monitoring server 20, a manager terminal to display the determination of reproduction by the user terminal 30 that is transmitted from the content monitoring server 20 on a screen, a guardian terminal 50 to display the determination of reproduction by the user terminal 30 that is transmitted from the content monitoring server 20 on a screen, and a data communication network 60 to allow communication among the content file service server 10, the content monitoring server 20, the user terminal 30, the manager terminal 40, and the guardian terminal 50.

The user terminal 30 includes an IPTV, and a PC as a device including a communication module 32, a multimedia content file reproduction device 31, and a user interface inputting user ratings.

The multimedia content file may be image data and audio data.

The multimedia file service server 10 outputs a user rating inputting guide message while providing image data provided by the multimedia content file service server 10 when the online connection to the multimedia content file service server 10 through the data communication network 60 in response to a signal input through the user interface 33, transmits the image data and user rating information to the content monitoring server 20 when the user rating is input in response to the user rating inputting guide message and the image data and the user rating information are selected and allows the selected image data to be downloaded to the user terminal 30 only when a reproduction execution signal is input from the content monitoring server 20.

The content monitoring server 20 receives the user rating information and the image data that are transmitted from the multimedia content file service server 10, extracts the genetic information from the image data, compares the extracted genetic information with pre-registered genetic information to determine whether there is similar genetic information, compares rating information of the image data with the user rating information when there is similar genetic information, and transmits a reproduction execution signal to the multimedia content file service server 10 when the user is allowed to watch the image data.

The content monitoring server 20 compares the rating information of the image data with the user rating information and transmits a reproduction prohibition signal to the multimedia content file service server 10, the manager terminal 40, and the guardian terminal 50 when the user is not allowed to watch the image data.

Operation of the multimedia content file management system using genetic information as constructed above will be described by restricting the multimedia content file to image data.

First, when a user contacts the multimedia content file service server 10 online through the communication module 32 of the user terminal 30, the multimedia content file service server 10 displays various contents including image contents and audio contents which the user may download online on a screen of the user terminal 30.

In this case, when the user selects desired image data through the user interface 33, the multimedia content file service server 10 outputs a user rating inputting guide message to the user terminal 30.

When the user inputs the user rating in response to the user rating inputting guide message of the multimedia content file service server 10, the multimedia content file service server 10 transmits the input user rating information and the selected image data to the content monitoring server 20.

Then, the content monitoring server 20 receives the user rating information and the image data that are transmitted from the multimedia content file service server 10, extracts genetic information from the image data, compares the extracted genetic information with pre-registered genetic information to determine whether there is similar genetic information, compares watching rating of the image data with the user rating information when there is the similar genetic information, and transmits a reproduction execution signal to the multimedia content file service server 10 when the user is allowed to watch the image data.

Then, the multimedia content file service server 10 allows the selected image data to be downloaded to the user terminal 30 only when the reproduction execution signal is input from the content monitoring server 20.

When the user is not allowed to watch the image data as a result of the comparison of the rating information of the image data with the user rating information, the content monitoring server 20 transmits not only a reproduction prohibition signal to the multimedia content file service server 10 but also to the manager terminal 40 and the guardian terminal 50.

Meanwhile, when any user uploads image data to the multimedia content file service server 10, the genetic generation module 11 of the multimedia content file service server 10 downloads the uploaded image data, generates genetic information, combines the generated genetic information with the multimedia file, and transmits the multimedia file with which the genetic information is combined to the content monitoring server 20.

Then, the content monitoring server 20 receives the multimedia file, with which the genetic information is combined, transmitted from the DNA generation module 11 to extract the genetic information combined with the multimedia file, compares the extracted genetic information with the pre-stored genetic information, determines that the image data has a copyright when there is similar genetic information as a result of the comparison, and allows the multimedia file to be downloaded when the user requests for downloading of the multimedia.

### Detailed Embodiment 2

### Case where a Multimedia Content File is Audio Data

Before describing this embodiment of the present invention, a reference numeral 110 refers to an audio DNA generation module or a first audio DNA generation module as occasion demands.

FIG. 2 is a schematic view illustrating a copyright management system according to this embodiment of the present invention.

Referring to FIG. 2, a content monitoring system according to this embodiment of the present invention includes an audio DNA generation module 110 loaded in the multimedia content file service server 100, downloading a multimedia file that is uploaded on the multimedia content file service server 100 to generate audio genetic information of the multimedia file, and combining the generated audio genetic information with the multimedia file to transmit, a content monitoring server 200 receiving the multimedia file, with which the audio genetic information is combined, transmitted from the audio DNA generation module 110, extracting the audio genetic information combined with the multimedia file, comparing the extracted audio genetic information with pre-stored audio genetic information, transmitting the result of the comparison when there is similar audio genetic information, and constructing copyright infringement information that is received from the outside into a database to store and mange the copyright infringement information, a manager terminal 300 displaying the compared results transmitted from the content monitoring server 200 on a screen and transmitting copyright infringement information that is input through the compared result screen to the content monitoring server 200, and a data communication network 400 allowing the multimedia content file service server 100, the content monitoring server 200, and the manager terminal 300 to communicate with each other.

The content monitoring server 200 includes a copyright management information database 210 in which multimedia files with copyright infringement information are stored and managed, a multimedia file database 220 in which multimedia files with a plurality of copyrights are stored, an audio genetic information database 230 to store a plurality of second audio genetic information, an illegal upload source information database 235 storing source information of a user terminal that illegally uploads a multimedia file with copyright as illegal upload source information by matching the source information of the user terminal to the multimedia file with copyright, a second audio genetic information generation module 240 reading the multimedia file with copyright that is registered in the multimedia file database 220 to generate audio genetic information of the multimedia file with copyright and storing the generated audio genetic information as second audio genetic information in the audio genetic information database 230, a receiver module 245 receiving the multimedia file, with which the audio genetic information is combined, transmitted from the first audio DNA generation module 110, a copyright infringement monitoring unit 250 receiving the multimedia file output from the receiver module 245 to extract the audio genetic information therefrom, comparing the audio genetic information as a first audio genetic information with the second audio genetic information that is registered in the audio genetic information database 230, determining whether there is similar genetic information as a result of the comparison, and transmitting the multimedia file and the compared result to the manager terminal 300 when there is the similar genetic information, an illegal upload source information updating unit 260 receiving the copyright infringement information transmitted from the manager terminal 300 and registering upload source of the multimedia file in the illegal upload source information database 235 when it is determined that the multimedia file that is monitored by the copyright infringement monitoring unit 250 infringes the copyright of the multimedia file.

The multimedia file is a file uploaded to a web-site.

Each of the first audio genetic information and the second genetic information includes at least one information of determining copyright of the multimedia file.

Operating method of the copyright management system using audio genetic information according to this embodiment of the present invention as constructed as illustrated in FIG. 2 will be described as follows.

Routine of Generating First Audio Genetic Information

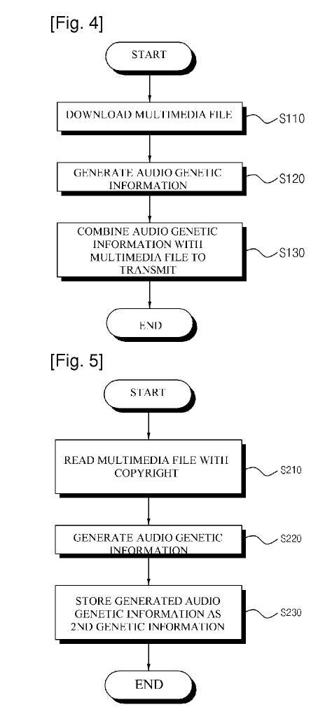

First, the first audio DNA generation module 110 loaded in the multimedia content file service server 100, as illustrated in FIG. 4, downloads the multimedia file uploaded to the multimedia content file service server 100 through the receiver module 245 (S110), generates the audio genetic information of the multimedia file (S120), and combines the generated audio genetic information with the multimedia file to transmit the multimedia file to the content monitoring server 200 (S130).

Routine of Generating Second Audio Genetic Information

The second audio genetic information generation unit 240 of the content monitoring server 200, as illustrated in FIG. 5, reads the multimedia file with copyright that is registered in the multimedia file database 220 (S210), generates audio genetic information of the multimedia file with copyright (S220), and stores the generated audio genetic information as second audio genetic information in the audio genetic information database 230 (S230).

Routine of Monitoring Copyright Infringement

The content monitoring server 200, which constructs a database of the audio genetic information of the multimedia file with copyright and which continuously updates the database, monitors multimedia files that are illegally distributed through the multimedia content file service server 100 using the copyright infringement monitoring unit 250.

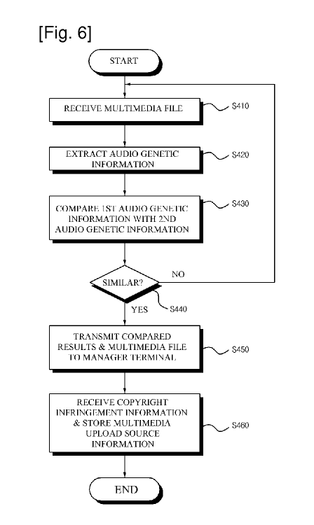

That is, the copyright infringement monitoring unit 250, as illustrated in FIG. 6, receives the multimedia file, with which the audio genetic information is combined, transmitted from the first audio DNA generation module 110 through the receiver module 210 (S410), extracts the audio genetic information from the multimedia file output from the receiver module 210 (S420), compares the audio genetic information as first audio genetic information with the second audio genetic information that is registered in the audio genetic information database 230 (S430), and determines whether there is similar genetic information as a result of the comparison (S440).

When there is similar genetic information as a result of the comparison (S440), the copyright infringement monitoring unit 250 transmits the multimedia file and the compared result to the manager terminal 300 (S450).

The content monitoring server 200 receives the copyright infringement information transmitted from the manage terminal 300 and allows the illegal upload source information updating unit 260 to register the upload source information of the multimedia file to the illegal upload source information database 235 to manage the same when it is determined that the multimedia file monitored by the copyright infringement monitoring unit 250 infringes copyright (S460). That is, when the multimedia files is illegally uploaded, an operator of the content monitoring server 200 manages a URL address of a home page to which the multimedia file is uploaded and takes an action of closing the corresponding home page for a preset period to make the multimedia file be legally distributed.

It is obvious to those skilled in the art that the similar genetic information in step S440 means that the first audio genetic information is identical to the second audio genetic information more than 50% or 70% as a result of the comparison and this may be changed or modified by the operator.

While the invention has been shown and described with respect to the preferred embodiments, it will be understood by those skilled in the art that various changes and modifications may be made without departing from the spirit and scope of the invention as defined in the following claims.

1. A multimedia content file management system using genetic information in which a multimedia file is downloaded and uploaded through a multimedia content file service server, the system comprising:
a DNA generation module, loaded in a multimedia content file service server, to download a multimedia file uploaded on the multimedia content file service server a to generate genetic information of the multimedia file, to combine the generated genetic information with the multimedia file for transmission; and
a content monitoring server to receive the multimedia file, with which the genetic information is combined, transmitted from the DNA generation module, to extract the genetic information combined with the multimedia file, and to output a compared result when there is genetic information similar to pre-stored genetic information by comparing the extracted genetic information with a pre-stored genetic information.

2. The multimedia content file management system of claim 1, further comprising:
a user terminal receiving the compared result transmitted from the content monitoring server, determining whether the multimedia content file selected by a user is reproduced, and transmitting the determination of reproduction to the content monitoring server;
a manager terminal displaying the determination of reproduction by the user terminal that is transmitted from the content monitoring server on a screen;
a data communication network allowing communication among the content file service server, the content monitoring server, the user terminal, and the manager terminal.

3. The multimedia content file management system of claim 2, wherein the user terminal comprises:
a content file reproduction device to which a communication module is loaded; and
a user interface inputting a user rating; and
wherein the multimedia content file comprises image data.

4. The multimedia content file management system of claim 2, wherein the multimedia content file service server outputs a user rating inputting guide message while providing image data provided by the multimedia content file service server when the online connection to the multimedia content file service server through the data communication network in response to a signal input through the user interface, transmits the image data and user rating information to the content monitoring server when the user rating is input in response to the user rating inputting guide message and the image data and the user rating information are selected and allows the selected image data to be downloaded to the user terminal only when a reproduction execution signal is input from the content monitoring server, and
wherein the content monitoring server receives the user rating information and the image data that are transmitted from the multimedia content file service server, extracts the genetic information from the image data, compares the extracted genetic information with pre-registered genetic information to determine whether there is similar genetic information, compares rating information of the image data with the user rating information when there is similar genetic information, and transmits a reproduction execution signal to the multimedia content file service server when the user is allowed to watch the image data.

5. The multimedia content file management system of claim 2, wherein the content monitoring server compares the rating information of the image data with the user rating information and transmits a reproduction prohibition signal to the multimedia content file service server and the manager terminal when the user is not allowed to watch the image data.

6. A multimedia content file management system using genetic information in which a multimedia file is downloaded and uploaded through a multimedia content file service server, the system comprising:
an audio DNA generation module loaded in the multimedia content file service server, downloading the multimedia content file that is uploaded on the multimedia content file service server to generate audio genetic information of the multimedia content file, and combining the generated audio genetic information with the multimedia content file to transmit;
a content monitoring server receiving the multimedia content file, with which the audio genetic information is combined, transmitted from the audio DNA generation module, extracting the audio genetic information combined with the multimedia content file, comparing the extracted audio genetic information with pre-stored audio genetic information, transmitting the result of the comparison when there is similar audio genetic information, and constructing copyright infringement information that is received from the outside into a database to store and mange the copyright infringement information;
a manager terminal displaying the compared results transmitted from the content monitoring server on a screen and transmitting copyright infringement information that is input through the compared result screen to the content monitoring server; and
a data communication network allowing the multimedia content file service server, the content monitoring server, and the manager terminal to communicate with each other.

7. The multimedia content file management system of claim 6, wherein the content monitoring server comprises:
a copyright management information database in which multimedia content files with copyright infringement information are stored and managed, a multimedia content file database in which multimedia content files with a plurality of copyrights are stored;
an audio genetic information database to store a plurality of second audio genetic information;
an illegal upload source information database storing source information of a user terminal that illegally uploads a multimedia content file with copyright as illegal upload source information by matching the source information of the user terminal to the multimedia content file with copyright, a second audio genetic information generation module reading the multimedia content file with copyright that is registered in the multimedia content file database to generate audio genetic information of the multimedia content file with copyright and storing the generated audio genetic information as second audio genetic information in the audio genetic information database;
a receiver module receiving the multimedia content file, with which the audio genetic information is combined, transmitted from the first audio DNA generation module;
a copyright infringement monitoring unit receiving the multimedia content file output from the receiver module to extract the audio genetic information therefrom, comparing the audio genetic information as a first audio genetic information with the second audio genetic information that is registered in the audio genetic information database, determining whether there is similar genetic information as a result of the comparison, and transmitting the multimedia content file and the compared result to the manager terminal when there is the similar genetic information; and
an illegal upload source information updating unit receiving the copyright infringement information transmitted from the manager terminal and registering upload source of the multimedia content file in the illegal upload source information database when it is determined that the multimedia content file that is monitored by the copyright infringement monitoring unit infringes the copyright of the multimedia content file.

8. The multimedia content file management system of claim 1, wherein the multimedia content file comprises a file uploaded to a web-site.

9. The multimedia content file management system of claim 1, wherein the audio genetic information combined with the multimedia content file comprises information of determining whether there is copyright information in the multimedia content file, and the genetic information comprises audio genetic information and video genetic information.

10. The multimedia content file management system of claim 1, wherein the pre-stored audio genetic information is generated from a multimedia content file with copyright which is downloaded or updated by the outside.

11. A copyright managing method using audio genetic information, comprising:
downloading a multimedia content file, by an audio DNA generation module loaded in a multimedia content file service server, that is uploaded to the multimedia content file service server;
generating audio genetic information of the multimedia content file; and
combining the generated audio genetic information with the multimedia content file to transmit the multimedia content file to a content monitoring server.

12. A copyright managing method using audio genetic information, comprising:
reading a multimedia content file with copyright that is registered in a multimedia file database by a content monitoring server;
generating audio genetic information of the multimedia content file with copyright; and
storing the generated audio genetic information as second audio genetic information in an audio genetic information database.

13. A copyright managing method using audio genetic information, comprising:
receiving a multimedia content file, with which audio genetic information is combined, transmitted from an audio DNA generation module by a content monitoring server, through a receiver module;
extracting the audio genetic information from the multimedia content file output from the receiver module;
comparing the audio genetic information as first audio genetic information with second audio genetic information that is registered in an audio genetic information database and determining whether there is similar genetic information as a result of the comparison; and
transmitting the multimedia content file and the compared result to a manager terminal when there is similar genetic information as a result of the comparison.

14. The copyright managing method of claim 13, further comprising receiving the copyright infringement information transmitted from the manage terminal and allowing an illegal upload source information updating unit to register upload source information of the multimedia content file to an illegal upload source information database to manage the same when it is determined that the multimedia content file monitored by a copyright infringement monitoring unit infringes copyright.

15. The copyright managing method of claim 11, wherein the multimedia content file comprises a file uploaded to a web-site.

16. The copyright managing method of claim 11, wherein the audio genetic information combined with the multimedia content file comprises information of determining whether there is copyright information in the multimedia content file.

17. The copyright managing method of claim 11, wherein the pre-stored audio genetic information is generated from a multimedia content file with copyright which is downloaded or updated by the outside.
